(19) United States
(12) Patent Application Publication
(10) Pub. No.: US 2024/0329753 A1
(43) Pub. Date: Oct. 3, 2024

(54) MULTIFUNCTIONAL CONTROL DEVICE FOR MULTIMEDIA

(71) Applicant: OXTI Pte Ltd, Singapore (SG)

(72) Inventor: Chih-Feng Ho, Singapore (SG)

(21) Appl. No.: 18/127,676

(22) Filed: Mar. 29, 2023

(51) Int. Cl. G06F 3/02; G06F 3/14; G06F 3/16

(52) U.S. Cl. CPC G06F 3/02; G06F 3/14; G06F 3/162

(57) ABSTRACT

A multifunctional control device for multimedia includes a multifunctional control device, which includes a transmitting/receiving module and at least one switching module. The switching module includes a switch button, which is electrically connected to the switching module. The switching module is electrically connected to the transmitting/receiving module. The multifunctional control device includes a charging circuit, and a storage battery that is electrically connected to the charging circuit. The storage battery is electrically connected to and supplies electrical power to the transmitting/receiving module and the switching module. A controlled device is connectable, through wired connection by a connection cable or wireless connection, to the multifunctional control device, such that a user may use the button of the multifunctional control device to conduct a fast operation of a displaying screen of the controlled device. Searching for a screen to be operated on the controlled device is no longer needed.

### TECHNICAL FIELD OF THE INVENTION

The present invention relates to a control device, and more particularly to a multifunctional control device for multimedia.

### DESCRIPTION OF THE PRIOR ART

Due to epidemic infectious diseases recently, people are often working from home or doing distance learning, and computers are commonly used for remote conferences or remote courses. However, if various applications must be used for communication with different customers, the operation of computer becomes extremely inconvenient. As shown in FIGS. 1 and 2, in a case that Skype is initially executed for a conference with a first customer, and during such a conference, a second customer calls and requires for communication with Zoom, then a computer mouse 200 or a keyboard 300 must be operated to shrink or close the image of Skype on the screen, and afterwards, the computer mouse 200 or the keyboard 300 is operated again to seek the image of Zoom on the screen for opening or activating the application. It generally takes a lot of time to complete such a process.

### SUMMARY OF THE INVENTION

In view of the above problem, an objective of the present invention is to provide a multifunctional control device for multimedia.

To achieve the above objective, the present invention provides a multifunctional control device for multimedia, which comprises:
a multifunctional control device, the multifunctional control device comprising a transmitting/receiving module, the multifunctional control device comprising at least one switching module, the switching module being provided with a switch button, the switch button being electrically connected to the switching module, the switching module being electrically connected to the transmitting/receiving module, the multifunctional control device comprising a charging circuit, the multifunctional control device comprising a storage battery, the storage battery being electrically connected to the charging circuit, the storage battery being electrically connected to and supplying electrical power to the transmitting/receiving module and the switching module; and
a controlled device, the controlled device being connectable, through wired connection by means of a connection cable or wireless connection, to the multifunctional control device, the controlled device comprising a display device, the display device comprising: a transmitting/receiving module; a master control circuit, the master control circuit being electrically connected to the transmitting/receiving module; a switching circuit, the switching circuit being electrically connected to the master control circuit; and a power supply, the power supply being operable to supply electrical power to the transmitting/receiving module, the a master control circuit, and the switching circuit, wherein when the controlled device is connected, through wired connection, to the multifunctional control device, the power supply 14 supplies electrical power to the charging circuit for charging.

By having the multifunctional control device electrically connected, through wired connection by means of a connection cable or wireless connection, to the controlled device, a user may use buttons on the multifunctional control device to fast carry out an operation on a screen of the controlled device, without the need to search for a screen for a desired operation on the controlled device, so that an effect of fast operation can be achieved.

### BRIEF DESCRIPTION OF THE DRAWINGS

FIG. 1 is a schematic view showing a known way of hosting a conference with application program Skype.

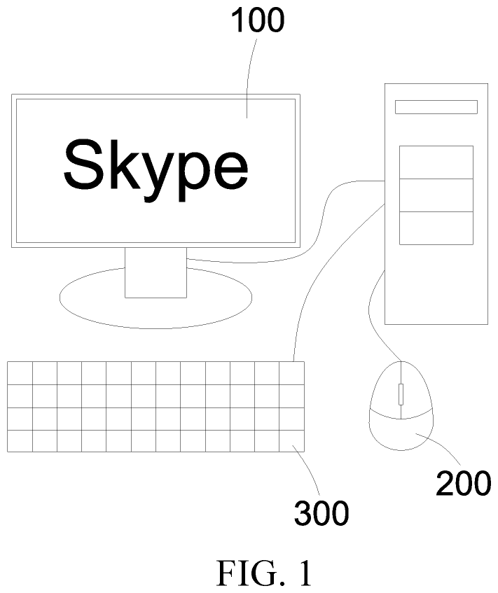

FIG. 2 is a schematic view showing a known way of hosting a conference with application program Zoom.

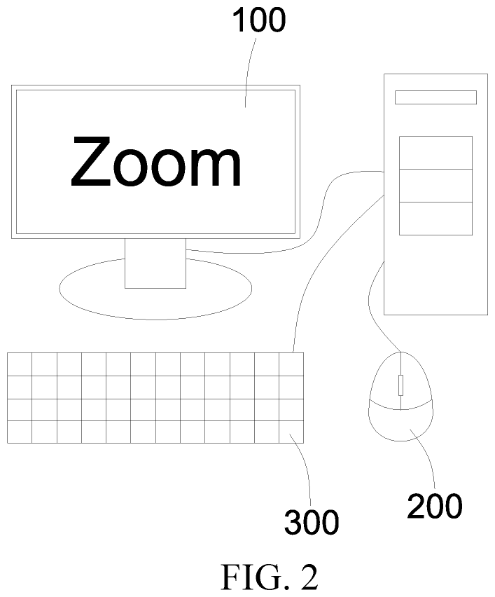

FIG. 3 is a schematic view showing the present invention.

FIG. 4 is a schematic view illustrating headphone charging according to the present invention.

FIG. 5 is a schematic view illustrating operation of the present invention.

FIG. 6 is a schematic view showing a sounding module included in the present invention.

FIG. 7 is a schematic view showing a conference held among a second-party communication device, a third-party communication device, and the present invention.

FIG. 8 is a perspective view of the present invention.

FIG. 9 is a schematic view demonstrating fast switchability of the present invention.

### DETAILED DESCRIPTION OF THE PREFERRED EMBODIMENT

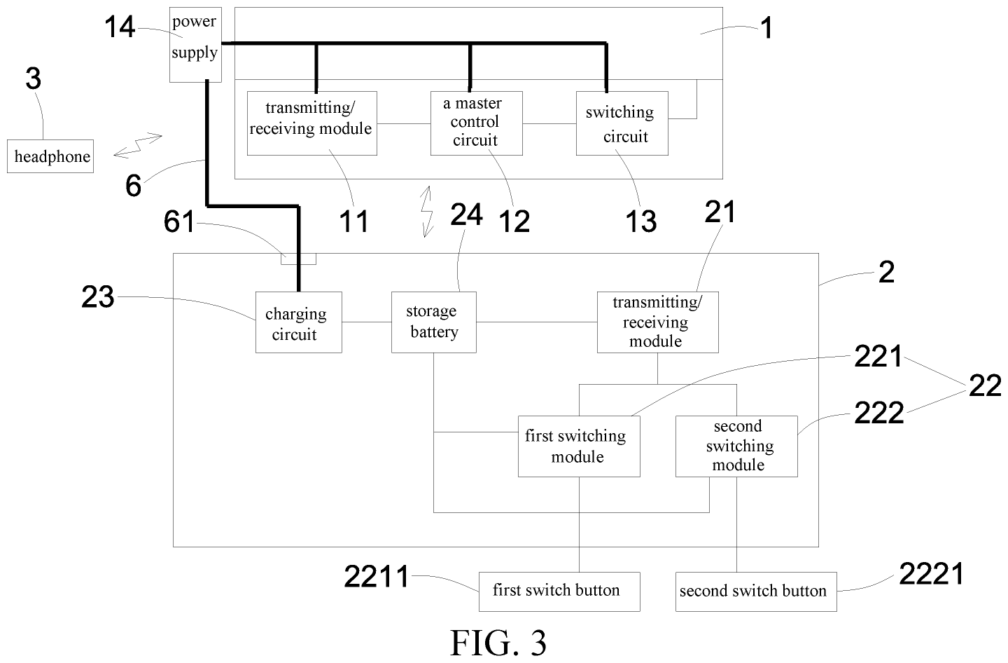

Referring to FIG. 3, a multifunctional control device for multimedia is shown, comprising:

a multifunctional control device 2, the multifunctional control device 2 comprising a transmitting/receiving module 21, the multifunctional control device 2 further comprising at least one switching module 22, which, in an example of the instant embodiment, includes a first switching module 221 and a second switching module 222, the first switching module 221 and the second switching module 222 being electrically connected to the transmitting/receiving module 21, the first switching module 221 and the second switching module 222 being respectively provided with a first switch button 2211 and a second switch button 2221, the first switch button 2211 and the second switch button 2221 being electrically connected to the first switching module 221 and the second switching module 222, the multifunctional control device 2 comprising a charging circuit 23, the multifunctional control device 2 comprising a storage battery 24, the storage battery 24 being electrically connected to the charging circuit 23, the storage battery 24 being electrically connected to and supplying electrical power to the transmitting/receiving module 21 and the switching module 22; and a controlled device 1, the controlled device 1 being connected, through wired connection by means of a connection cable 6 or wireless connection, to the multifunctional control device 2, the controlled device 1 being selectively a display device, the display device comprising: a transmitting/receiving module 11; a master control circuit 12, the master control circuit 12 being electrically connected to the transmitting/receiving module 11; a switching circuit 13, the switching circuit 13 being electrically connected to the master control circuit 12; and a power supply 14, the power supply 14 supplying electrical power to the transmitting/receiving module 11, the master control circuit 12, and the switching circuit 13, wherein when the controlled device 1 is connected, in a wired manner, to the multifunctional control device 2, the power supply 14 supplies electrical power to the charging circuit 23 for charging thereto, and the charging circuit 23 in turns charges the electrical power into the storage battery 24,
wherein when the controlled device 1 and the multifunctional control device 2 are not in wired connection by means of the connection cable 6 (such as a Type C connector), the storage battery supplies electrical power to the transmitting/receiving module 21 and the switching module 22;
wherein the switching module 22 is optionally increased or expanded according to environment requirement (such as muting, screen switching, screen sharing, image projecting, and the likes);
wherein the display device comprises a displaying screen;
wherein the wireless connection comprises Bluetooth;
wherein the connection cable 6 comprises a Type C connector; and
wherein the multifunctional control device comprises a plugging hole 61, and the plugging hole 61 receives the Type C connector to insert therein so as to achieve wired connection between the multifunctional control device 2 and the controlled device 1.

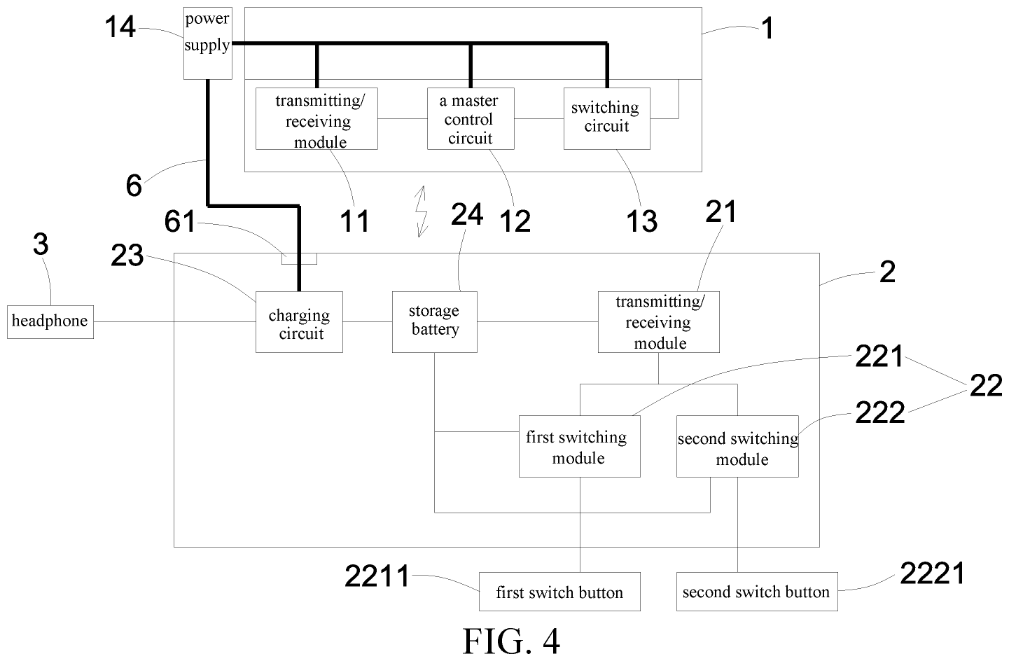

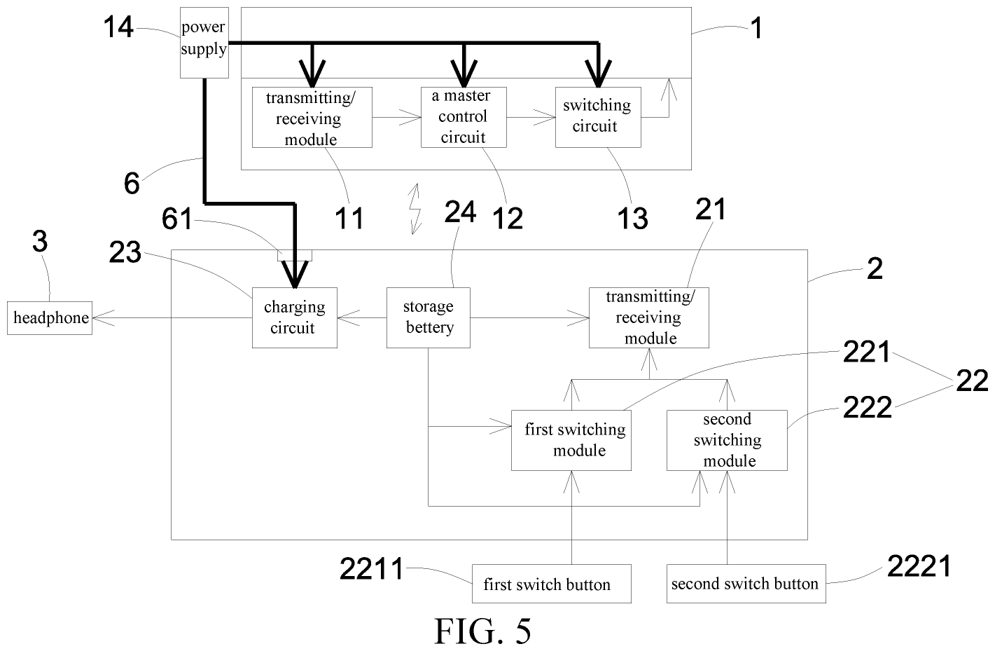

Referring to FIGS. 3 and 4, a headphone 3 is optionally set in wired connection by means of the connection cable 6 or wireless connection with the multifunctional control device 2 or the controlled device 1, so that in a noisy environment, a user may use the headphone 3 for operation and the headphone 3 is individually connectable with the charging circuit 23 for electrical connection therebetween for charging, as shown in FIG. 5.

Referring to FIG. 5, with the multifunctional control device 2 being connected, through wired connection by means of the connection cable 6 or wireless connection, to the controlled device 1, the first switch button 2211 or the second switch button 2221 can be selectively pressed and activated to have the first switching module 221 or the second switching module 222 to transmit a signal of switching to the transmitting/receiving module 21, and the transmitting/receiving module 21 transmits the signal to the controlled device 1, to be transmitted by means of the transmitting/receiving module 11 through the master control circuit 12 to the switching circuit 13, and the switching circuit 13 then controls the controlled device 1 to switch the screen so as to achieve an effect of fast operation, and when the multifunctional control device 2 is connected, through wireless connection, to the controlled device 1, the storage battery 24 supplies electrical power to the multifunctional control device 2.

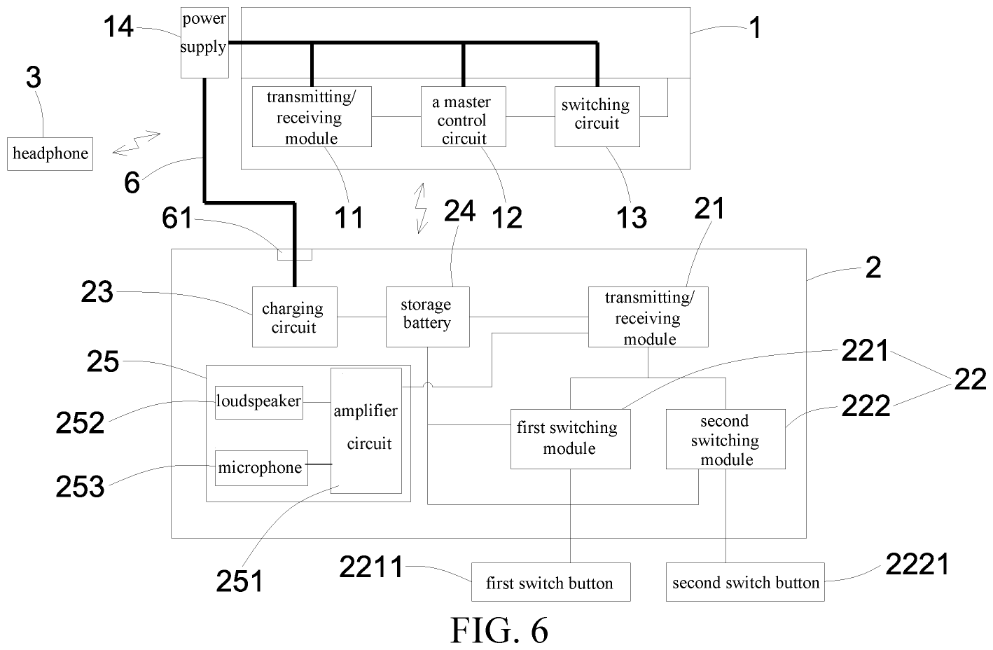

Referring to FIG. 6, the multifunctional control device 2 may further comprises a sounding module 25, and the sounding module 25 is electrically connected to the transmitting/receiving module 21. And further, the sounding module 25 comprises an amplifier circuit 251, a loudspeaker 252, and a microphone 253. The loudspeaker 252 and the microphone 253 are electrically connected to the amplifier circuit 251. A voice signal is transmitted from the transmitting/receiving module 11 of the controlled device 1 to the transmitting/receiving module 21 of the multifunctional control device 2, and is then transmitted from the transmitting/receiving module 21 to the amplifier circuit 251 of the sounding module 25, and is then transmitted from the amplifier circuit 251 to the loudspeaker 252, so that a sound from the controlled device 1 can be directly outputted by means of the sounding module 25 of the multifunctional control device 2; and a received sound can be transmitted from the microphone 253 through the amplifier circuit 251 to the transmitting/receiving module 21 to be then transmitted by the transmitting/receiving module 21 to the transmitting/receiving module 11 of the controlled device 1, so that the sounding module 25 is operable to transmit a sound received or picked up thereby to the controlled device 1.

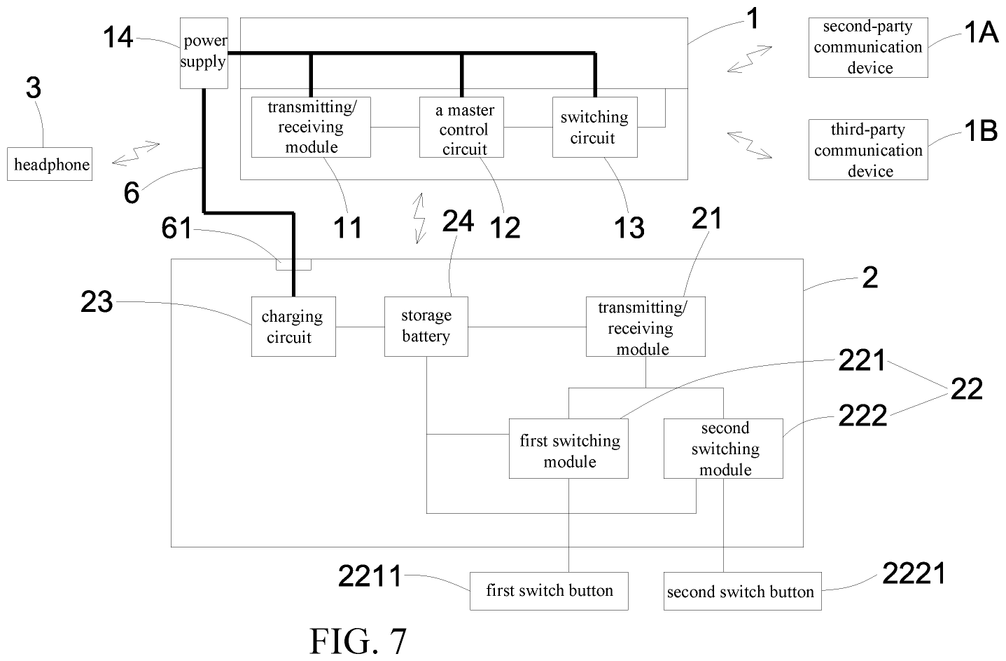

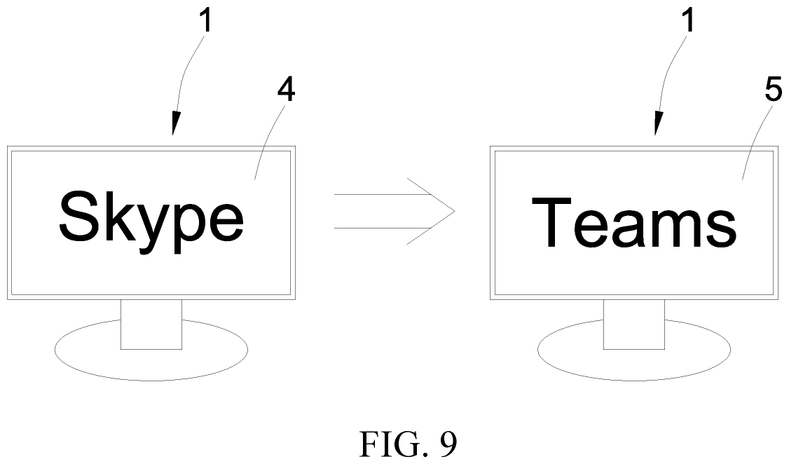

Referring to FIGS. 7, 8, and 9, a user, when attempting to switch the screen during a video conference conducted with a second-party communication device 1A by using the controlled device 1, while requiring a discussion with a third-party communication device 1B, may activate the first switch button 2211 or the second switch button 2221 of the switching module 22 of the multifunctional control device 2 to carry out screen switching. For example, when the conference is conducted in a first screen 4 (such as Skype), if use of a second screen 5 (such as Teams) for a conference is temporarily desired, it only needs to activate or press down the second switch button 2221 to switch to the second screen 5, so that there is no need for the user to seek, on the controlled device 1, for the location for screen switching, and thus an effect of fast screen switching is achieved, and also, the number of the switching module 22 can be increased or expanded as desired to suit environment requirement.

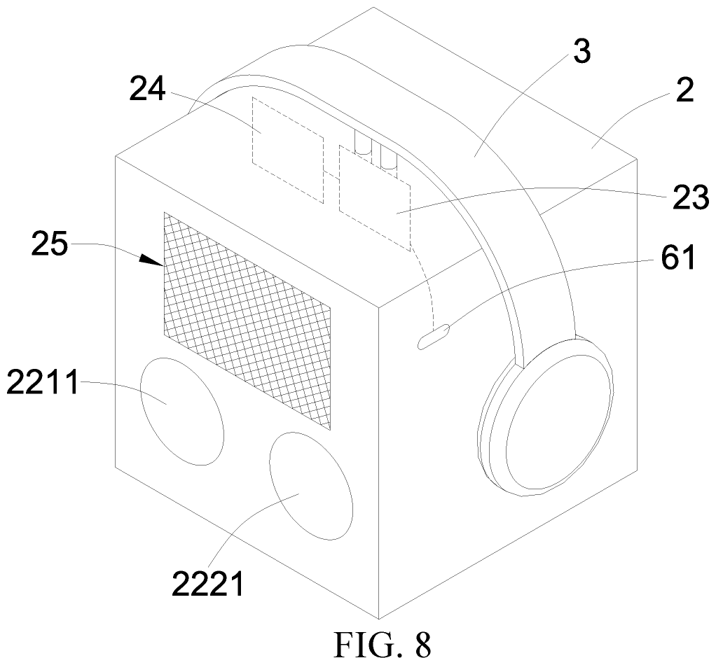

By providing the switching module 22 on the multifunctional control device 2, the user, when using the multifunctional control device 2, is allowed to do fast screen switching for the controlled device 1 to achieve an effect of fast operation. Further, by providing the charging circuit 23 on the multifunctional control device 2, when the headphone 3 is running out of electrical power, the user may connect the headphone 3 to the charging circuit 23 to carry out charging into the headphone 3 (as shown in FIG. 8). Further, by providing the sounding module 25 on the multifunctional control device 2, the multifunctional control device 2 may additionally provide an effect of the loudspeaker.

I claim:

1. A multifunctional control device for multimedia, comprising:
a multifunctional control device, the multifunctional control device comprising a transmitting/receiving module, the multifunctional control device also comprising at least one switching module, the switching module being provided with a switch button, the switch button being electrically connected to the switching module, the switching module being electrically connected to the transmitting/receiving module, the multifunctional control device comprising a charging circuit, the multifunctional control device comprising a storage battery, the storage battery being electrically connected to the charging circuit, the storage battery being electrically connected to and supplying electrical power to the transmitting/receiving module and the switching module; and
a controlled device, the controlled device being connectable, through wired connection by means of a connection cable or wireless connection, to the multifunctional control device.

2. The multifunctional control device for multimedia according to claim 1, wherein the controlled device comprises a display device.

3. The multifunctional control device for multimedia according to claim 2, wherein the display device comprises a transmitting/receiving module; a master control circuit, the master control circuit being electrically connected to the transmitting/receiving module; a switching circuit, the switching circuit being electrically connected to the master control circuit; and a power supply, the power supply being operable to supply electrical power to the transmitting/receiving module, the master control circuit, and the switching circuit.

4. The multifunctional control device for multimedia according to claim 1, wherein the multifunctional control device comprises a sounding module, the sounding module comprising an amplifier circuit, a loudspeaker, and a microphone, the loudspeaker and the microphone being electrically connected to the amplifier circuit.

5. The multifunctional control device for multimedia according to claim 1, wherein the connection cable comprises a Type C connector.
